(19) United States
(12) Patent Application Publication
(10) Pub. No.: US 2017/0164568 A1
(43) Pub. Date: Jun. 15, 2017

(54) DRIP IRRIGATION EMITTER

(71) Applicant: Chi-Sung TSAI, Kaohsiung City (CN)

(72) Inventor: Chi-Sung TSAI, Kaohsiung City (CN)

(21) Appl. No.: 14/965,756

(22) Filed: Dec. 10, 2015

(51) Int. Cl. A01G 25/02

(52) U.S. Cl. CPC A01G 25/023; A01G 25/026

(57) ABSTRACT

A drip irrigation emitter has an outer element and a flow-restricting element. The outer element has a channel, an inlet and an outlet. The flow-restricting element is detachably mounted in the channel of the outer element. The flow-restricting element has a body, a passageway, a piercing portion and multiple notches. The passageway is helically formed around the body and has a caliber. The piercing portion is mounted on the body and protrudes out of the inlet. The notches are formed around the body between a first end surface of the body and the piercing portion and are in communication with the passageway. Each one of the notches has a caliber that is smaller than the caliber of the passageway to prevent the passageway from obstruction by the impurities. The piercing portion can directly pierce into a water supply tube for adjusting to plants accurately.

### BACKGROUND OF THE INVENTION

1. Field of the Invention

The present invention relates to a drip irrigation emitter, and more particularly to a drip irrigation emitter that is mounted on a water supply tube for irrigating plants at a slow rate.

2. Description of Related Art

The concept of drip irrigation was developed several years ago. Now the drip irrigation is one of the most popular methods for irrigation. The drip irrigation uses a water supply tube and multiple drip irrigation emitters. The water supply tube has a hollow body and multiple through holes. The through holes are formed through an external surface of the hollow body at intervals. The drip irrigation emitters are mounted in the through holes and inserted into the hollow body of the water supply tube.

In use, plants are planted at spaced intervals. The water supply tube is deposited near plants. The drip irrigation emitters mounted on the water supply tube are respectively close to plants. Water in the water supply tube can flow out of the drip irrigation emitters to irrigate plants.

Users plant the plants along a planted line, and an interval between two adjacent plants at a front section of the planted line is not equal to an interval between two adjacent plants at a rear section of the planted line. The interval inaccuracy is generated by users. However, the intervals between the through holes formed on the hollow body are the same, the intervals between the drip irrigation emitters are the same, and the position of each one of the drip irrigation emitters is fixed. Therefore, the positions of the drip irrigation emitters cannot be adjusted and aligned with plants accurately. The irrigation efficiency of the conventional drip irrigation is not good.

To overcome the shortcomings, the present invention tends to provide a drip irrigation emitter to mitigate or obviate the aforementioned problems.

### SUMMARY OF THE INVENTION

The main objective of the invention is to provide a drip irrigation emitter that may directly pierce into a water supply tube to adjust to and align with plants accurately for improving the irrigation efficiency.

The drip irrigation emitter has an outer element and a flow-restricting element. The outer element has a base, a first head, a second head, a channel, an inlet and an outlet. The base has a first surface and a second surface. The first surface is defined on the base. The second surface is defined on the base and is opposite to the first surface of the base. The first head is formed on and protrudes from the first surface of the base. The first head has an outer surface, a distal end, a cone surface and multiple engaging protrusions. The cone surface is formed on the outer surface of the first head and is connected to the first surface of the base. The engaging protrusions are formed on the outer surface of the first head at intervals. The second head is formed on and protrudes from the second surface of the base, and has a distal end. The channel is formed through the base, the first head, and the second head. The inlet is formed in the distal end of the first head and is in communication with the channel. The outlet is formed in the distal end of the second head and is in communication with the channel. The flow-restricting element is detachably mounted in the channel via the inlet and the first head of the outer element. The flow-restricting element has a body, a threaded portion, a passageway, a piercing portion and multiple notches. The body has a first end surface formed on the body adjacent to the inlet of the outer element. The threaded portion is helically formed around the body between the two end surfaces of the body. The passageway is helically formed around the body by the threaded portion between the two end surfaces of the body and has a caliber. The piercing portion is mounted on the first end surface of the body and protrudes out of the inlet of the outer element. The notches are formed around the body between the first end surface of the body and the piercing portion and are in communication with the passageway. Each one of the notches has a caliber that is smaller than the caliber of the passageway.

A hollow body of a water supply tube, without through holes formed in an outer surface of the water supply tube, can be pierced by the piercing portion of the drip irrigation emitter directly according to the user's need. The position of the drip irrigation emitter mounted on the water supply tube can be accurately adjusted according to plants for improving the irrigation efficiency. Furthermore, water in the water supply tube flows in the channel via the notches and the passageway, and then flows out of the outlet of the outer element via the channel to irrigate the corresponding plant. The caliber of each one of the notches is smaller than the caliber of the passageway. The notches can stop the impurities in the water supply tube from flowing into the drip irrigation emitter. The notches may prevent the passageway from obstruction by the impurities.

Moreover, the passageway is helical, and this may increase the flowing distance in the drip irrigation emitter. The flow rate of the water in the drip irrigation emitter is slow for saving water. The drip irrigation emitter is efficient at using water resource. The flow-restricting element is detachably mounted in the outer element. The flow-restricting element can be detached from the outer element for cleaning and reuse.

### BRIEF DESCRIPTION OF THE DRAWINGS

FIG. 1 is an exploded perspective view of a first embodiment of a drip irrigation emitter in accordance with the present invention;

FIG. 2 is a side view in partial section of the drip irrigation emitter in FIG. 1;

FIG. 3 is a side view in partial section of the drip irrigation emitter along line 3-3 in FIG. 2;

FIG. 4 is an operational side view in partial section of the drip irrigation emitter in FIG. 1, mounted on a water supply tube by piercing the water supply tube;

FIG. 5 is an operational side view of the drip irrigation emitter in FIG. 1, mounted on the water supply tube and irrigating plants;

FIG. 6 is another operational side view in partial section of the drip irrigation emitter in FIG. 1, mounted on the water supply tube and connected to a pipe;

FIG. 7 is a side view of a first embodiment of a flow-restricting element of the drip irrigation emitter in FIG. 1;

FIG. 8 is a side view of a second embodiment of a flow-restricting element of the drip irrigation emitter in FIG. 1; and

FIG. 9 is a side view in partial section of a second embodiment of the drip irrigation emitter in accordance with the present invention.

### DETAILED DESCRIPTION OF PREFERRED EMBODIMENT

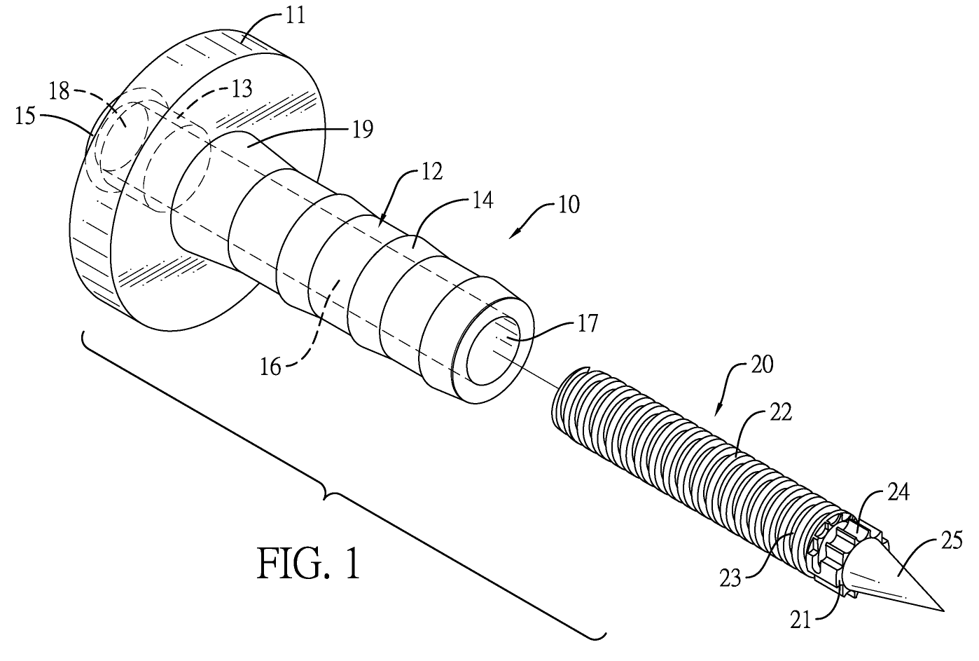

With reference to FIGS. 1 to 3, a first embodiment of a drip irrigation emitter in accordance with the present invention comprises an outer element 10 and a flow-restricting element 20.

The outer element 10 has a base 11, a first head 12, a second head 13, a channel 16, an inlet 17, an outlet 18, and a flange 15. The base 11 has a first surface and a second surface. The second surface of the base 11 is opposite to the first surface of the base 11. The first head 12 is formed on and protrudes from the first surface of the base 11. The first head 12 has an outer surface, a distal end, a cone surface 19, and multiple engaging protrusions 14. The cone surface 19 is formed around the outer surface of the first head 12 and is connected to the first surface of the base 11. The engaging protrusions 14 are formed around the outer surface of the first head 12 at intervals between the cone surface 19 and the distal end of the first head 12. The second head 13 is formed on and protrudes from the second surface of the base 11 and has a distal end.

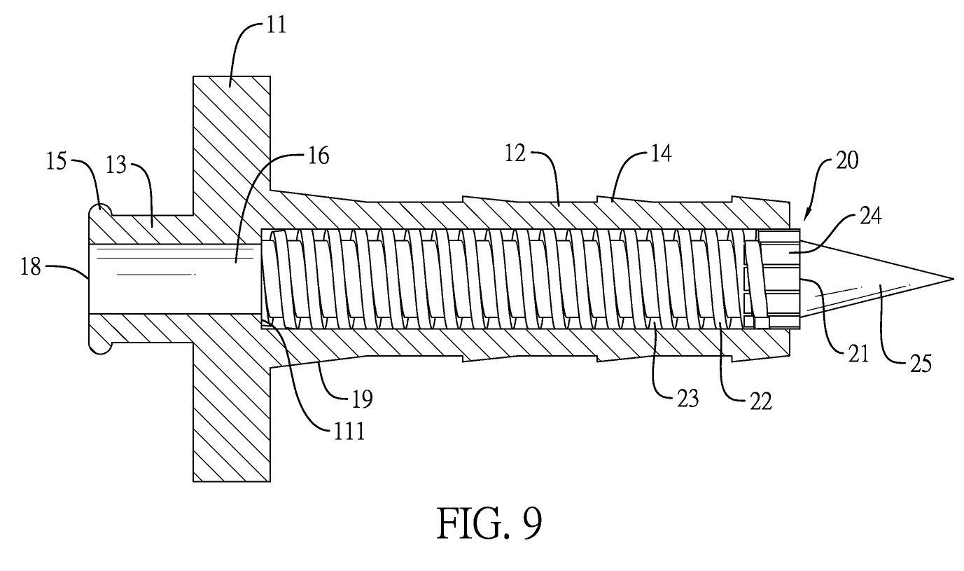

The channel 16 is formed through the base 11, the first head 12, and the second head 13. The inlet 17 is formed in the distal end of the first head 12 and is in communication with the channel 16. The outlet 18 is formed in the distal end of the second head 13 and is in communication with the channel 16. The flange 15 is annularly formed on the second head 13 around the outlet 18. With reference to FIG. 9, in a second embodiment of the drip irrigation emitter, the outer element 10 further has a retaining surface 111. The retaining surface 111 is annularly formed in the outer element 10 adjacent to the base 11 to form a stepped face between the base 11 and the first head 12.

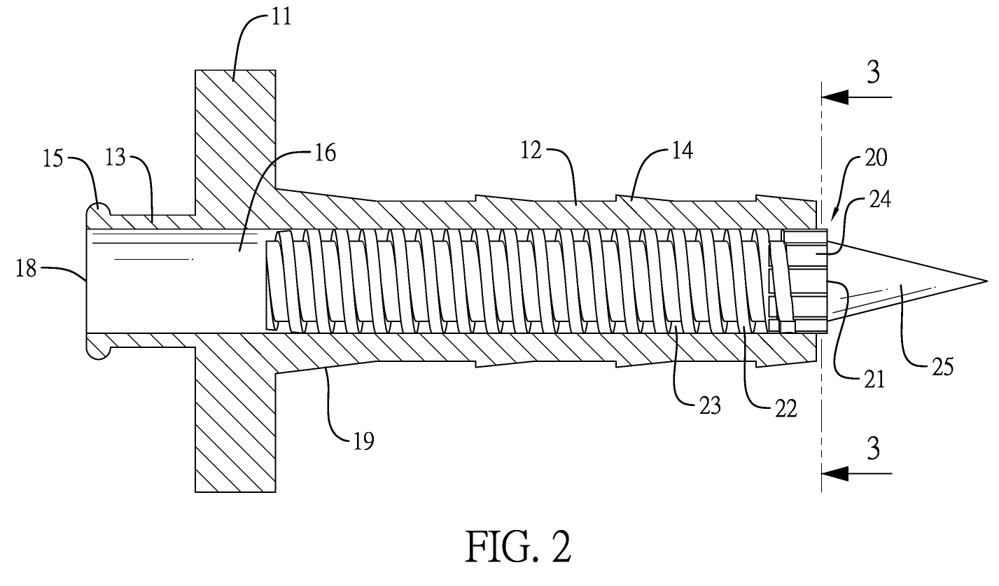

With reference to FIGS. 2 and 9, the flow-restricting element 20 is detachably mounted in the channel 16 via the inlet 17 and the first head 12 of the outer element 10. The flow-restricting element 20 has a body 21, a threaded portion 22, a passageway 23, a piercing portion 25, and multiple notches 24. The body 21 has a first end surface and a second end surface. The first end surface of the body 21 is formed on the body 21 adjacent to the inlet 17 of the outer element 10. The second end surface of the body 21 is formed on the body 21 opposite to the first end surface of the body 21. In the second embodiment of the present invention, the second end surface of the body 21 abuts against the retaining surface 111 of the outer element 10 to limit the position of the body 21.

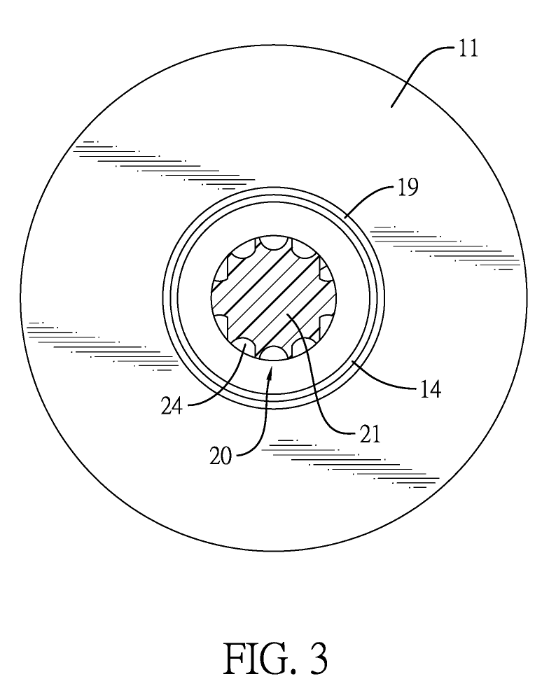

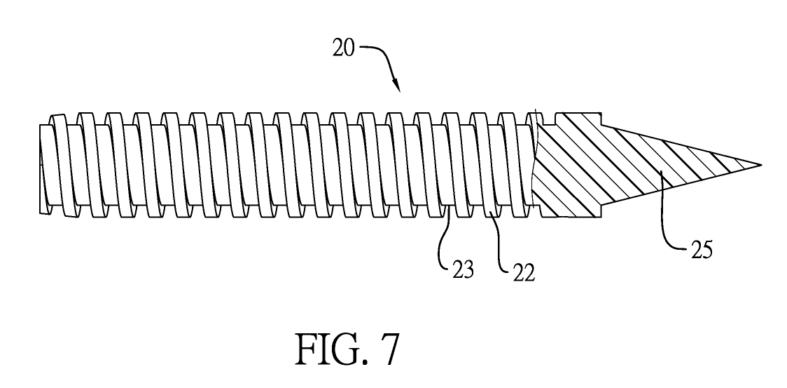

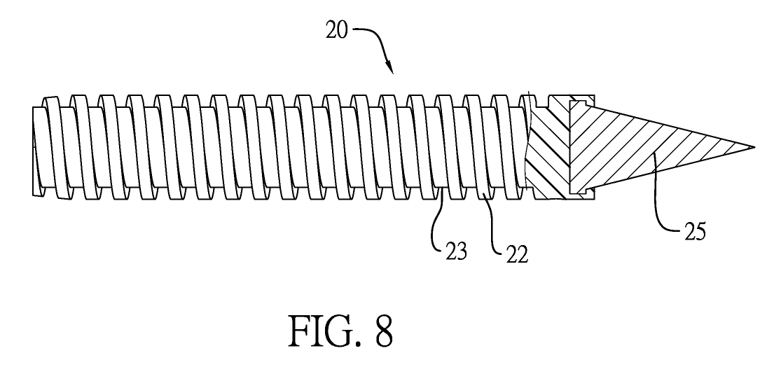

The threaded portion 22 is helically formed around the body 21 between the two end surfaces of the body 21. The passageway 23 is helically formed around the body 21 by the threaded portion 22 between the two end surfaces of the body 21 and has a caliber. The piercing portion 25 is mounted on the first end surface of the body 21 and protrudes out of the inlet 17 of the outer element 10. With reference to FIG. 7, the piercing portion 25 may be made of plastic, and is integrated with the body 21. With reference to FIG. 8, the piercing portion 25 may be made of metal, and the body 21 is connected to the piercing portion 25 by injection overmolding. With reference to FIGS. 2 and 3, the notches 24 are formed around the body 21 between the first end surface and the piercing portion 25 and are in communication with the passageway 23. Each one of the notches 24 has a caliber that is smaller than the caliber of the passageway 23.

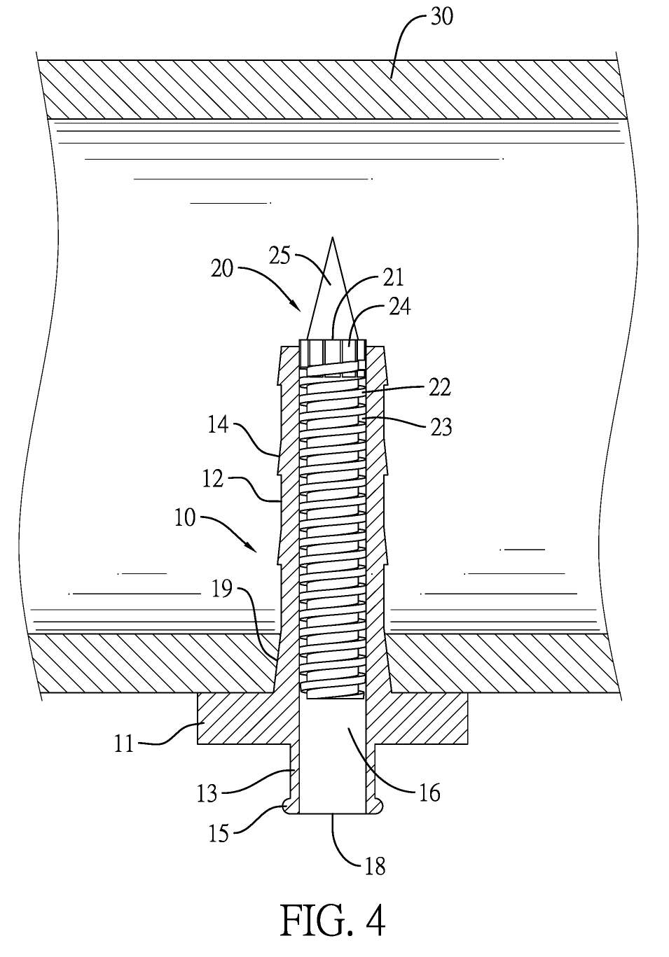

With reference to FIG. 4, the piercing portion 25 of the drip irrigation emitter is pierced into a water supply tube 30 without forming through holes in an outer surface of the water supply tube 30, and then the drip irrigation emitter is mounted on the water supply tube 30 directly and quickly according to the user's need. The first head 12 of the outer element 10 is inserted into the water supply tube 30 by the piercing portion 25 piercing into the water supply tube 30. The first surface of the base 11 of the outer element 10 abuts against the outer surface of the water supply tube 30. Furthermore, the cone surface 19 presses against the water supply tube 30 at the outer surface of the water supply tube 30. The outer element 10 cannot slide out of the water supply tube 30 due to the engaging protrusions 14.

Water in the water supply tube 30 flows in the channel 16 via the notches 24 and the passageway 23 of the flow-restricting element 20, and then flows out of the outlet 18 of the outer element 10 via the channel 16.

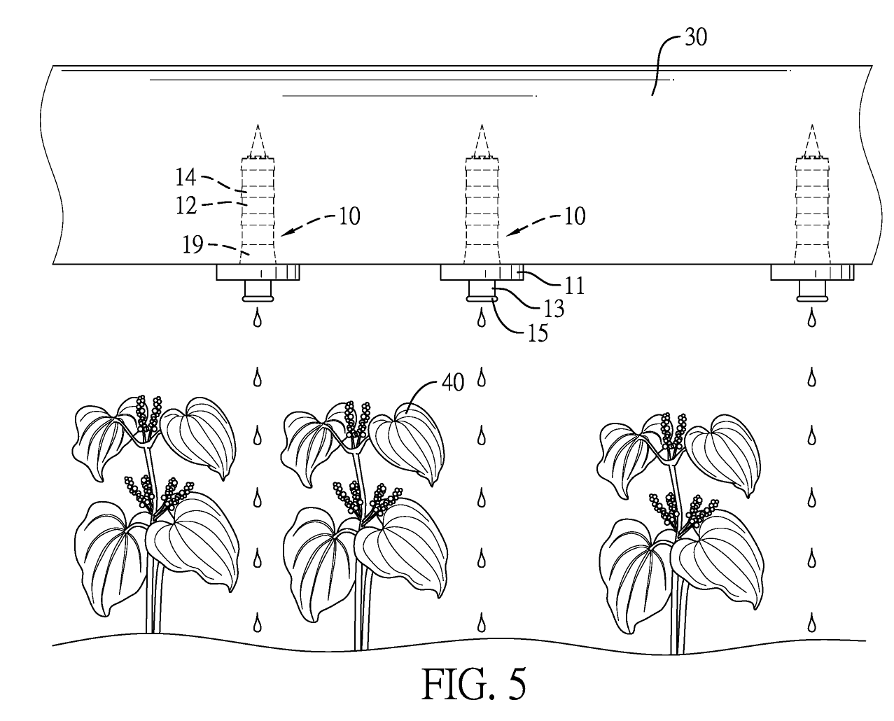

With reference to FIG. 5, the water supply tube 30 is deposited above plants 40. Multiple drip irrigation emitters directly pierce into and are mounted on the water supply tube 30. The positions of the drip irrigation emitters can be adjusted for irrigating plants 40 respectively and accurately by the user.

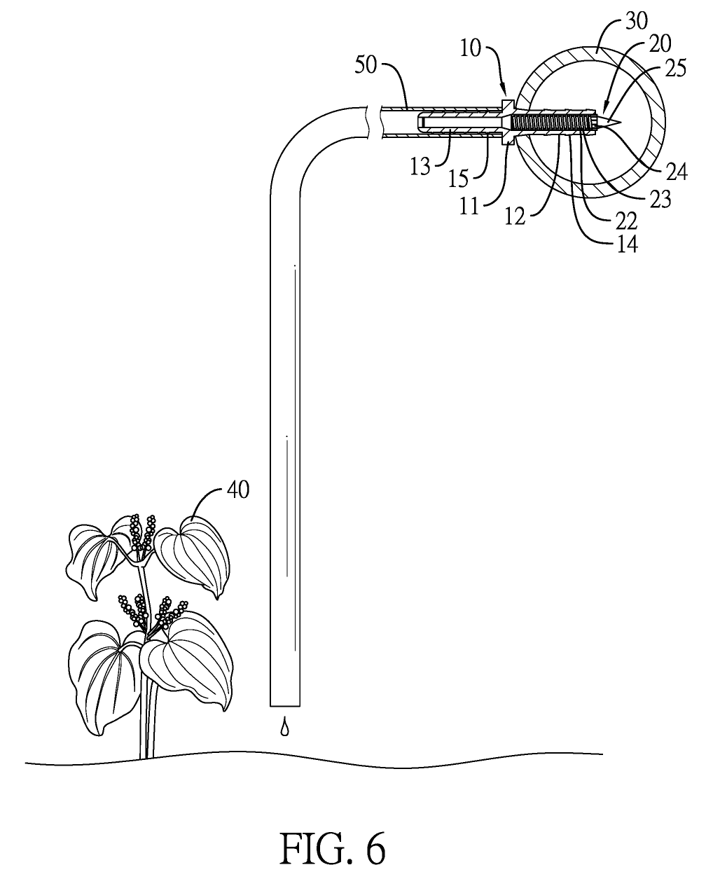

With reference to FIG. 6, the water supply tube 30 is deposited beside plants 40. When the water supply tube 30 is at a distance relative to one of the plants 40, a pipe 50 can be securely mounted around the second head 13 of the outer element 10 by the flange 15. A distal end of the pipe 50 is deposited near the corresponding plant 40. Water flows out of the drip irrigation emitter, further flows through the pipe 50, and then flows out of the distal end of the pipe 50 for irrigating the corresponding plant 40.

Furthermore, the drip irrigation emitter can be mounted on a plastic bottle to irrigate a potted plant.

If the passageway 23 is blocked by limescale in the water, the drip irrigation emitter can be detached from the water supply tube 30 by pulling the second head 13 of the outer element 10, and then a tool is inserted into the outer element 10 via the outlet 18. The flow-restricting element 20 is pushed out of the outer element 10 by the tool to clean out limescale retained in the passageway 23. The flow-restricting element 20 is convenient to detach from the outer element 10 and to clean the passageway 23 of the flow-restricting element 20. The flow-restricting element 20 can be re-mounted into the outer element 10 after cleaning.

For positioning the flow-restricting element 20 in the outer element 10, the channel 16 of the outer element 10 may be in a conical shape. A caliber of the inlet 17 is larger than a caliber of the outlet 18. Or the flow-restricting element 20 has a spacing ring formed around the first end surface of the body 21. An outer diameter of the spacing ring is larger than the caliber of the inlet 17, and the spacing ring may limit the position of the flow-restricting element 20. With reference to FIG. 9, the second end surface of the flow-restricting element 20 abuts against the retaining surface 111 of the outer element 10. When water flows through the flow-restricting element 20, the flow-restricting element 20 is positioned and cannot move out of the outlet 18 of the outer element 10 by the engagement between the retaining surface 111 and the second end surface of the flow-restricting element 20.

Accordingly, the piercing portion 25 of the drip irrigation emitter can directly pierce into the water supply tube 30. The position of the drip irrigation emitter mounted on the water supply tube 30 is easy to adjust by the user according to the positions of plants 40 accurately. The irrigation efficiency of the drip irrigation emitter may be improved. The caliber of each one of the notches 24 is smaller than the caliber of the passageway 23. Then, the notches 24 may prevent the passageway 23 from obstruction by the impurities.

In addition, the passageway 23 is helical, and this may increase the flowing distance in the drip irrigation emitter. The flow rate of water in the drip irrigation emitter is slow for saving water. The drip irrigation emitter is efficient at using water resource. The flow-restricting element 20 is detachably mounted in the outer element 10 and is convenient for cleaning and reuse.

What is claimed is:

1. A drip irrigation emitter comprising:
an outer element having
a base having
a first surface defined on the base; and
a second surface defined on the base and being opposite to the first surface of the base;
a first head formed on and protruding from the first surface of the base, and having
an outer surface;
a distal end;
a cone surface formed around the outer surface of the first head and connected to the first surface of the base; and
multiple engaging protrusions formed around the outer surface of the first head at intervals;
a second head formed on and protruding from the second surface of the base, and having a distal end;
a channel formed through the base, the first head, and the second head;
an inlet formed in the distal end of the first head and communicating with the channel; and
an outlet formed in the distal end of the second head and communicating with the channel; and
a flow-restricting element detachably mounted in the channel via the inlet and the first head of the outer element, and having
a body having
a first end surface formed on the body adjacent to the inlet of the outer element;
a second end surface formed on the body and opposite to the first end surface of the body;
a threaded portion helically formed around the body between the two end surfaces of the body;
a passageway helically formed around the body by the threaded portion between the two end surfaces of the body, and having a caliber;
a piercing portion mounted on the first end surface of the body and protruding out of the inlet of the outer element; and
multiple notches formed around the body between the first end surface of the body and the piercing portion, the notches communicating with the passageway, and each one of the notches having
a caliber smaller than the caliber of the passageway.

2. The drip irrigation emitter as claimed in claim 1, wherein the outer element has a flange, and the flange is annularly formed on the second head around the outlet.

3. The drip irrigation emitter as claimed in claim 1, wherein
the outer element has a retaining surface annularly formed in the outer element adjacent to the base to form a stepped face between the base and the first head; and
the second end surface of the body of the flow-restricting element abuts against the retaining surface of the outer element.

4. The drip irrigation emitter as claimed in claim 2, wherein
the outer element has a retaining surface annularly formed in the outer element adjacent to the base to form a stepped face between the base and the first head; and
the second end surface of the body of the flow-restricting element abuts against the retaining surface of the outer element.

5. The drip irrigation emitter as claimed in claim 1, wherein the piercing portion is made of plastic and is integrated with the body.

6. The drip irrigation emitter as claimed in claim 2, wherein the piercing portion is made of plastic and is integrated with the body.

7. The drip irrigation emitter as claimed in claim 3, wherein the piercing portion is made of plastic and is integrated with the body.

8. The drip irrigation emitter as claimed in claim 4, wherein the piercing portion is made of plastic and is integrated with the body.

9. The drip irrigation emitter as claimed in claim 1, wherein the piercing portion is made of metal, and the body is connected to the piercing portion by injection overmolding.

10. The drip irrigation emitter as claimed in claim 2, wherein the piercing portion is made of metal, and the body is connected to the piercing portion by injection overmolding.

11. The drip irrigation emitter as claimed in claim 3 wherein the piercing portion is made of metal, and the body is connected to the piercing portion by injection overmolding.

12. The drip irrigation emitter as claimed in claim 4, wherein the piercing portion is made of metal, and the body is connected to the piercing portion by injection overmolding.
